(19) United States
(12) Patent Application Publication
(10) Pub. No.: US 2007/0078758 A1
(43) Pub. Date: Apr. 5, 2007

(54) Risk assessment-based shopping of internet auctions

(76) Inventors: Robert Aaron Susskind, Reno, NV (US); Peter Douglas Beery, Cedar Park, TX (US)

Correspondence Address: Robert A. Susskind, House 206, 9900 Wilbur May Parkway, Reno, NV, 89521, US

(21) Appl. No.: 11/507,395

(22) Filed: Aug. 22, 2006

Related U.S. Application Data
(60) Provisional application No. 60/719,711, filed on Sep. 23, 2005.

(51) Int. Cl. G06Q 40/00

(52) U.S. Cl. 705/38; 705/37

(57) ABSTRACT

A method and process for simultaneously searching one or more internet auctions, augmented with automatic seller ratings expressing risk-of-injury to a buyer, with the steps of: A search parameter entry client, An artificial intelligence-based analysis engine that generates ratings of sellers expressing risk-of-injury to a buyer, An easy to understand ‘rating’ display automatically presented to the buyer, A server system that accepts requests for rating sellers and returns the desired ratings, A web browser or instant messenger component or web page that monitors a buyer's current URL and which interacts with the server system to return and display the seller's ‘rating’ when the buyer is browsing an online auction listing, A web browser or instant messenger component or web page that interacts with the server system to allow a search of the online auction service platform which returns a sorted list of rated sellers.

### CROSS REFERENCE TO RELATED APPLICATIONS

This application claims priority from provisional application Ser. No. 60/719,711, filed on Sep. 23, 2005.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of Internet auction shopping/bidding, and more specifically to a method for enabling automated and semi-automated search for items, rating of sellers, and repeatable queries, for use by shoppers and bidders of items on Internet auction sites. This invention specifically provides a method of rating each seller and performing a comparison of multitudes of sellers by a variety of sorted, ordered criteria.

Within this text, the terms “bidder”, “shopper”, and “buyer” refer to anyone participating on an Internet “online” auction site such as www.ebay.com in the role of a potential or actual purchaser of products or services. The terms are used interchangeably.

### CURRENT STATE OF THE ART

A number of options exist which allow shoppers/bidders/buyers to search for items and services at online auction systems. The existing art allows searches based upon details specific to the item being sold such as: seller ID, item number, item category(s), color, function, condition, brand, et cetera. The current art also allows the searcher to review certain details about specific sellers such as: number of items sold, number of items currently for sale, satisfaction level of previous customers, proximity to buyer, et cetera.

### SHORTCOMINGS AND INADEQUACIES OF THE PRIOR ART

The existing Art does not provide a way to automatically rate the “risk of injury” to a buyer of all sellers offering items matching a shopper's search criteria and to sort the search results on the basis of such seller ratings. The term “risk of injury” is used herein to mean the relative likelihood that a buyer may have an unwanted outcome when purchasing from a seller, as well as the relative quality of a seller as compared to all other sellers in a population of sellers on a specific auction site. The prior art shortcomings expose shoppers/buyers to potential risk of injury by not providing a simple means for shoppers/buyers to effectively choose from a group of sellers offering comparable products, those sellers most likely to deliver a product or service and complete the sale in a satisfactory fashion thereby minimizing the risk of injury.

Further, the shortcomings of available processes and tools are amplified when such processes are applied to shopping across multiple auction sites, presenting a virtually impossible task. The sheer volume of sellers, items for sale, and auction sites, present too much information for a human being to digest. Establishing a valid decision-making process as to which sellers to trust, which sellers to avoid, which sellers meet one or more criteria, which items to bid on, and so forth, is a virtual impossibility. In all, the shopping experience on online auctions using available tools and methods does not work nearly as effectively as would be possible using the methods and processes described in this invention.

### BRIEF SUMMARY OF THE INVENTION

The primary object of the invention is to reduce risk of injury to a bidder/buyer of online auctions associated with sellers with a history of problems on previous auctions by automatically rating the quality of all sellers that have items available that match the buyer's search criteria and providing to the buyer a way to sort search results by seller quality.

Another object of the invention is to automatically assess the risk associated with a seller of any one auction.

Another object of the invention is to generate and show to the shopper an easy to understand risk of injury ‘rating’ value associated with a seller for any one auction.

Another object of the invention is to allow the buyer to manually submit an anonymous assessment of their experience with any seller.

Another object of the invention is to automatically capture a buyer's anonymous assessment of their experience with any seller by tracking usage patterns of a buyer.

Another object of the invention is to automatically capture usage patterns including product interests of the buyer across several online auction systems.

A further object of the invention is to show a more detailed risk assessment of the seller upon interactive request by a shopper.

Yet another object of the invention is to provide an intuitively understood risk of injury ‘rating’ value for each of one or more sellers returned from a search on the online auction service platform.

Still yet another object of the invention is to display a sorted list of ‘rated’ sellers returned from a search on the online auction service platform.

Another object of the invention is to, upon interactive request by a shopper, show a more detailed risk assessment for a seller who appears on a sorted list of ‘rated’ sellers returned from a search on an online auction site(s).

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a process for automatically and semi-automatically assessing the risk of injury to a shopper/bidder/buyer participating in online auctions comprising the steps of: An artificial intelligence based feedback history analysis engine that generates a ‘rating’ of risk of injury to a buyer for an online auction seller, An easy to understand ‘rating’ display which is automatically presented to the buyer, A server system that accepts requests for rating individual sellers and returns the desired rating of risk of injury to a buyer to the requester, A server system that accepts search requests for an online auction service platform and returns a sorted list of rated sellers show relative risk of injury to a buyer with auctions that match the search criteria, A server system that accepts requests for a more detailed risk of injury assessment for an individual seller and returns the more detailed report to the requester, A web browser component that automatically monitors the a shopper's current URL and which automatically interacts with the server system to return and display a risk of injury rating when the shopper is browsing an online auction listing, An instant messenger component that interacts with the server system to return and display a risk of injury to a buyer rating when the buyer is browsing an online auction listing, A secondary web browser window and web site that interacts with the server system to return and display a rating of risk of injury to a buyer when the buyer is browsing an online auction listing, A web browser component that interacts with the server system to allow a search of the online auction service platform which returns a sorted list of rated sellers who have auctions that match the search criteria, An instant messenger component that interacts with the server system to allow a search of the online auction service platform which returns a sorted list of rated sellers who have auctions that match the search criteria, and a web site that interacts with the server system to allow a search of the online auction service platform which returns a sorted list of rated sellers who have auctions that match the search criteria, A means of filtering or grouping online auction search results lists based upon seller rating; Other bidder interface components such as cell phones, wireless Personal Digital Assistants (PDAs), interactive television, et cetera are anticipated.

### BRIEF DESCRIPTION OF THE SEVERAL VIEWS OF THE DRAWINGS

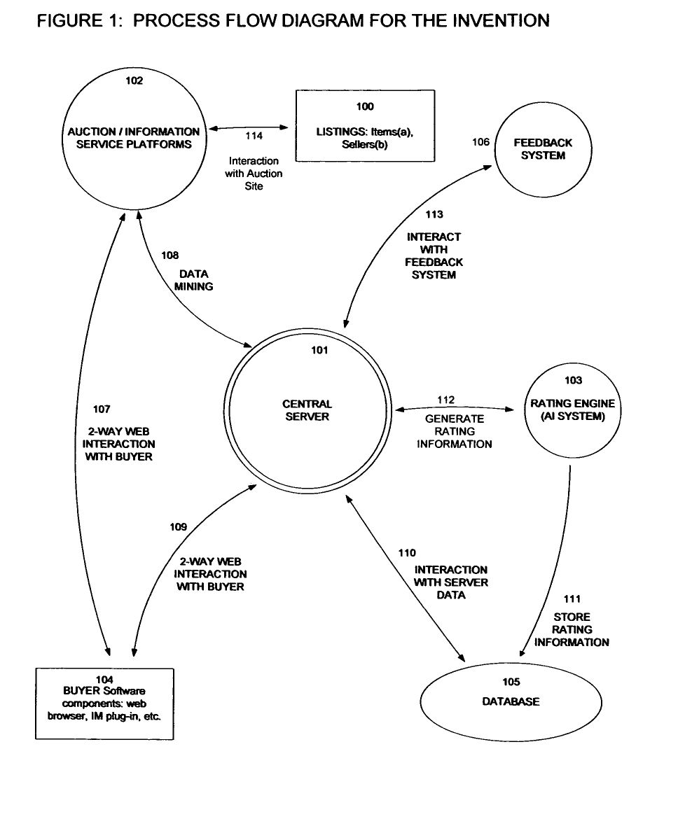

Listing of Figures: there is 1 drawing, “FIG. 1: Process Flow Diagram for the Invention”, referenced.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### DETAILED DESCRIPTION OF THE INVENTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

This invention relates generally to the field of risk management and more specifically to a method of searching auctions 102 for specific items 100(a) with automatic assessment of seller 100(b) quality.

The core of this invention is, essentially, a set of services running on a server 101 including an artificial intelligence (hand crafted ‘expert system’) based seller rating engine 103 and a set of software components (web browser, web browser toolbar plug-in, instant messenger plug-in) used by the buyer 104. These services interact 108 on a regular scheduled basis with the auction service platforms 102 and render seller ratings showing relative risk of injury to a buyer 112 which are stored 111 in a database 105. Ratings are calculated in part from feedback 106 left on the auction service platform itself and in part from usage information gathered 109 from the buyer 104. The web browser component 104 allows searches 107 across multiple auction and information service platforms 102. Search results are returned to the buyer 104 from both the auction and information service platforms, and from the central server 101. The central server 101 supplies the seller ratings to the buyer's web browser component 104 which are merged with the auction platform 102 search results and presented in a sort able format. The web browser tool bar plug-in and instant messenger plug-in 104 allow the web browser component to be integrated / launched from existing web browsers and instant messenger clients 104.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A process for automatically and semi-automatically assessing the risk of injury to a shopper/bidder/buyer participating in online auctions and fixed-price sites when considering bidding on or purchasing an item for sale, comprising the steps of:
An artificial intelligence based feedback history analysis engine that generates a risk of injury to a buyer ‘rating’ for an online auction seller;
An easy to understand ‘rating’ display which is automatically presented to the shopper/bidder/buyer;
A server system that accepts requests for rating individual sellers and returns the desired risk of injury to a buyer rating to the requester;
A server system that accepts search requests for an online auction service platform and returns a sorted list of risk of injury to a buyer rated sellers with auctions that match the search criteria;
A server system that accepts requests for a more detailed risk of injury to a buyer assessment for an individual seller and returns the more detailed report to the requester;
A web browser component that automatically monitors the buyer's current URL and which automatically interacts with the server system to return and display a risk of injury to a buyer rating when the buyer is browsing an online auction listing.

2. A process for automatically and semi-automatically assessing the risk of injury to a shopper/bidder/buyer participating in online auctions and fixed-price sites as claimed in claim 1 further comprising:
An instant messenger component that interacts with the server system to return and display a risk of injury to a buyer rating when the buyer is browsing an online auction listing.

3. A process for automatically and semi-automatically assessing the risk of injury to a shopper/bidder/buyer participating in online auctions and fixed-price sites as claimed in claim 1 further comprising:
A secondary web browser window and web site that interacts with the server system to return and display a risk of injury to a buyer rating when the buyer is browsing an online auction listing.

4. A web browser component as described in claim 1 that further interacts with the server system to allow a search of the online auction service platform which returns a sorted list of risk of injury to a buyer rated sellers who have auctions that match the search criteria.

5. An instant messenger component as described in claim 2 that further interacts with the server system to allow a search of the online auction service platform which returns a sorted list of risk of injury to a buyer rated sellers who have auctions that match the search criteria.

6. A secondary web browser window and web site as described in claim 3 that further interacts with the server system to allow a search of the online auction service platform which returns a sorted list of risk of injury to a buyer rated sellers who have auctions that match the search criteria.

7. A web browser component as described in claim 1 that further allows the buyer to manually submit an anonymous assessment of their experience with the seller.

8. A web browser component as described in claim 1 and 7 that further automatically submits a buyer's anonymous assessment of their experience with the seller by capturing usage patterns of the buyer to a server system.

9. A web browser component as described in claims 1, 7, and 8 that further automatically captures to a server system usage patterns including product interests of the buyer across several online auction systems.

10. A web browser component as described in claims 1, 7, 8, and 9 that further provides a means of comparing items across a multitude of auction sites in combination with a multitude of fixed-price sites using a primary criterion of seller rating and secondary criteria using information available from each site including but not limited to: price, time left, high bid, payment method, and country of origin.

11. An instant messenger component as described in claim 2 and 5 that further allows the buyer to manually submit an anonymous assessment of their experience with the seller.

12. An instant messenger component as described in claim 2, 5, and 11 that further automatically submits a buyer's anonymous assessment of their experience with the seller by capturing usage patterns of the buyer to a server system.

13. An instant messenger component as described in claim 2, 5, 11, and 12 that further automatically captures to a server system usage patterns including product interests of the buyer across several online auction systems.

14. An instant messenger component as described in claim 2, 5, 11, 12, and 13 that further provides a means of comparing items across a multitude of auction sites in combination with a multitude of fixed-price sites using a primary criterion of seller rating and secondary criteria using information available from each site including but not limited to: price, time left, high bid, payment method, and country of origin.
Other bidder interface components such as cell phones, wireless Personal Digital Assistants (PDAs), interactive television, et cetera are anticipated.
